(19) United States
(12) Patent Application Publication
(10) Pub. No.: US 2003/0197143 A1
(43) Pub. Date: Oct. 23, 2003

(54) Solenoid valve

(75) Inventors: Keiichi Kai, Gunma (JP); Masato Kumagai, Saitama (JP)

Correspondence Address: SUGHRUE, MION, ZINN, MACPEAK & SEAS, PLLC, 2100 Pennsylvania Avenue, N.W., Washington, DC, 20037-3202, US

(73) Assignee: HITACHI UNISIA AUTOMOTIVE, LTD.

(21) Appl. No.: 10/394,249

(22) Filed: Mar. 24, 2003

(30) Foreign Application Priority Data
Apr. 19, 2002 (JP) 2002-118213
Apr. 19, 2002 (JP) 2002-118212

(51) Int. Cl. F16K 31/02

(52) U.S. Cl. 251/129.17

(57) ABSTRACT

A solenoid valve comprises a diaphragm type valve member installed in a casing. The valve member is movable between an open position wherein the valve member is separated from a valve seat thereby to open the same and a close position wherein the valve member is seated on the valve seat thereby to close the same. The valve member has thereon a magnetic material. A biasing member is provided for biasing the valve member in a direction to cause the valve member to assume the close position. An electromagnetic actuator is installed in the casing. The actuator has a work part that faces the valve member. The work part produces a magnetic force to attract the valve member causing the same to assume the open position against a biasing force of the biasing member when the actuator is energized and producing no magnetic force to leave the valve member causing the same to assume the close position due to the biasing force of the biasing member when the actuator is deenergized.

### BACKGROUND OF THE INVENTION

1. Field of Invention

The present invention relates in general to solenoid valves, and more particularly to the solenoid valves of a type that is suitable for use as a purge control valve of an evaporation purge system for automotive internal combustion engines.

2. Description of Related Art

One of automotive emission control systems is an evaporation purge system that captures any fuel vapors coming from the fuel tank. It prevents the vapors from escaping into the atmosphere. That is, when the engine is shut off, the fuel vapors feed from the fuel tank into a charcoal canister. The activated charcoal in the canister traps or adsorbs the fuel vapors. Later, when the engine starts and becomes to take a certain operation condition, a purge control valve is opened permitting fresh air to flow through the canister and pick up the fuel vapor. The air then flows into the intake manifold and becomes part of the air/fuel mixture entering the engine cylinders.

In the system, there is arranged an evaporation purge line that extends between the intake manifold and the canister. The purge control valve is installed in the evaporation purge line and when the purge control valve takes its open position, the fuel vapor, that has been trapped by the canister, is drawn into the intake manifold for burning in the engine cylinders together with the air/fuel mixture. Usually, a solenoid valve is used as the purge control valve, which is equipped with an electromagnetic actuator for electromagnetically controlling open/close action of a valve proper.

However, due to its inherent construction, it is difficult to provide the solenoid valve with a responsive open/close operation especially when the valve proper thereof is of a slider type that frictionally slides in a bore. Furthermore, it is often seen that the power produced by the electromagnetic actuator is not effectively used for moving the valve proper.

### SUMMARY OF THE INVENTION

It is therefore an object of the present invention to provide a solenoid valve or purge control valve that ensures a responsive open/close operation of a valve proper and ensures effective usage of a power produced by an electromagnetic actuator.

According to a first aspect of the present invention, there is provided a solenoid valve which comprises a casing defining therein inlet and outlet passages and a valve seat, the valve seat establishing a fluid communication between the inlet and outlet passages when opened and blocking the fluid communication when closed; a diaphragm type valve member installed in the casing, the valve member being movable between an open position wherein the valve member is separated from the valve seat thereby to open the same and a close position wherein the valve member is seated on the valve seat thereby to close the same, the valve member having thereon a magnetic material; a biasing member that biases the valve member in a direction to cause the valve member to assume the close position; and an electromagnetic actuator installed in the casing, the actuator having a work part that faces the valve member, the work part producing a magnetic force to attract the valve member causing the same to assume the open position against a biasing force of the biasing member when the actuator is energized and producing no magnetic force to leave the valve member causing the same to assume the close position due to the biasing force of the biasing member when the actuator is deenergized.

According to a second aspect of the present invention, there is provided a solenoid valve which comprises a casing defining therein inlet and outlet passages and a valve seat, the valve seat establishing a fluid communication between the inlet and outlet passages when opened and blocking the fluid communication when closed; a diaphragm type valve member installed in the case, the valve member being movable between an open position wherein the valve member is separated from the valve seat thereby to open the same and a close position wherein the valve member is seated on the valve seat thereby to close same, the valve member having hereon a magnetic material; a biasing coil that biases the valve member in a direction to cause the valve member to assume the close position; and an electromagnetic actuator installed in the casing, the actuator comprising a core rod, an electromagnetic coil coaxially mounted on the core rod through a coil bobbin and a yoke member including two arm members by which the core rod is held, wherein the arm members have inwardly extending lower portions whose leading ends face each other with a given clearance left therebetween, and wherein the lower portions face an upper surface of the valve member thereby to serve as a work part of the electromagnetic actuator, the work part producing a magnetic force applied to the magnetic material of the valve member when the actuator is energized.

According to a third aspect of the present invention, there is provided a solenoid valve which comprises a casing defining therein inlet and outlet passages and a valve seat, the valve seat establishing a fluid communication between the inlet and outlet passages when opened and blocking the fluid communication when closed; a diaphragm type valve member installed in the case, the valve member being movable between an open position wherein the valve member is separated from the valve seat thereby to open the same and a close position wherein the valve member is seated on the valve seat thereby to close same, the valve member having hereon a magnetic material; a biasing coil that biases the valve member in a direction to cause the valve member to assume the close position; and an electromagnetic actuator installed in the casing, the actuator comprising a core rod, an electromagnetic coil coaxially mounted on the core rod through a coil bobbin and a yoke member including two arm members by which the core rod is held, wherein the arm members have upper portions connected through a bridge member and inwardly extending lower portions whose leading ends face each other with a given clearance left therebetween, wherein the core rod has an upper end secured to the bridge member and a lower end positioned between the leading ends of the inwardly extending lower portions of the arm members with a given clearance left therebetween, and wherein the inwardly extending lower portions of the arm members and the lower end of the core rod face the upper surface of the valve member thereby to serve as a work part of the electromagnetic actuator, the work part producing a magnetic force applied to the magnetic material of the valve member when the actuator is energized.

Other objects and advantages of the present invention will become apparent from the following description when taken in conjunction with the accompanying drawings.

### BRIEF DESCRIPTION OF THE DRAWINGS

FIG. 1 is a vertically sectioned view of a solenoid valve which is a first embodiment of the present invention;

FIG. 2 is a sectional view taken along the line “II-II” of FIG. 1;

FIG. 3 is an external view of the solenoid valve of the first embodiment, which is taken from the same direction as in FIG. 1;

FIG. 4 is an external view of the solenoid valve of the first embodiment, which is taken from the direction of the arrow “IV” of FIG. 3;

FIG. 5 is an exploded view of essential parts of an electromagnetic actuator employed in the solenoid valve of the first embodiment;

FIG. 6 is a schematic view showing a closed magnetic circuit provided by the electromagnetic actuator of the solenoid valve of the first embodiment;

FIG. 7 is a graph showing a relation between a strength of electric current fed to the electromagnetic actuator of the solenoid valve of the first embodiment and an attractive force produced by the electromagnetic actuator;

FIG. 8 is an external view similar to FIG. 3, but showing a solenoid valve of a second embodiment of the present invention;

FIG. 9 is an external view of the solenoid valve of the second embodiment, which is taken from the direction of the arrow “IX” of FIG. 8;

FIG. 10 is a vertically sectioned view of a solenoid valve which is a third embodiment of the present invention;

FIG. 11 is a sectional view taken along the line “XI-XI” of FIG. 10;

FIG. 12 is an external view of the solenoid valve of the first embodiment, which is taken from the same direction as in FIG. 10;

FIG. 13 is an external view of the solenoid valve of the third embodiment, which is taken from the direction of the arrow “XIII” of FIG. 12;

FIG. 14 is an exploded view of essential parts of the electromagnetic actuator employed in the solenoid valve of the third embodiment; and

FIG. 15 is a schematic view showing a magnetic circuit provided by the electromagnetic actuator of the solenoid valve of the third embodiment.

### DETAILED DESCRIPTION OF THE EMBODIMENTS

In the following, three embodiments 100, 200 and 300 of the present invention will be described in detail with reference to the accompanying drawings.

For ease of understanding, various directional terms, such as right, left, upper, lower, rightward and the like are used in the description. However, such terms are to be understood with respect to only a drawing or drawings on which the corresponding part or portion is shown. Throughout the drawings, substantially same parts or portions are denoted by the same numerals.

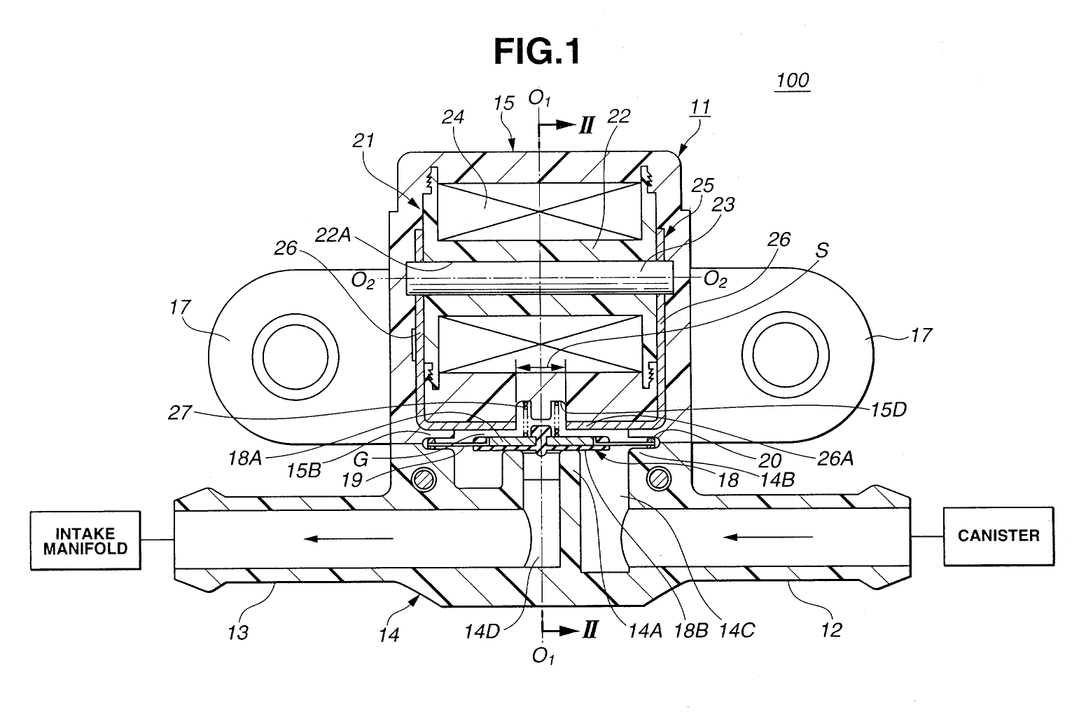

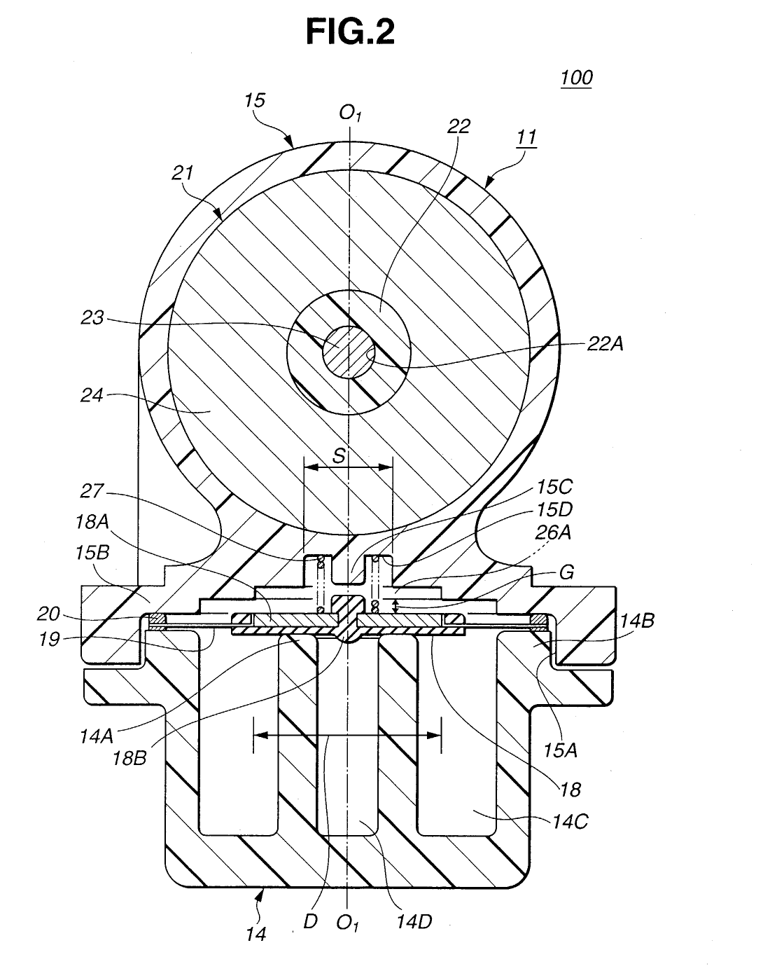

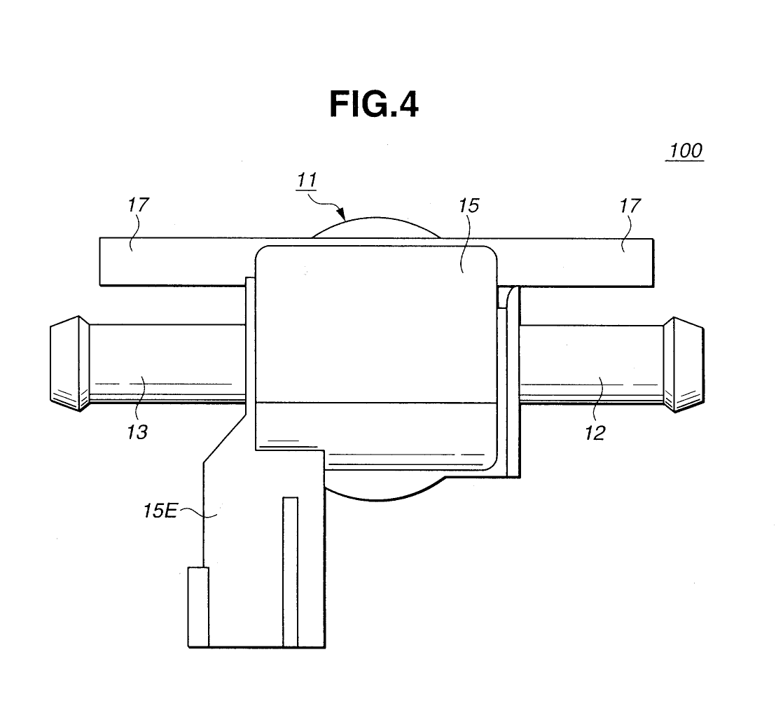

Referring to FIGS. 1 to 7, particularly FIGS. 1 and 2, there is shown a solenoid valve 100 of a first embodiment of the present invention, which is used as a purge control valve.

In FIGS. 1 and 2, denoted by numeral 11 is a split-type casing made of a molded plastic. As is understood from these drawings, casing 11 generally comprises two parts, which are a lower part 14 that has inlet and outlet pipes 12 and 13 which are aligned, and an upper part 15 that is detachably mounted on lower part 14 in an after-mentioned manner.

It is now to be noted that when the solenoid valve 100 is used as a purge control valve, inlet pipe 12 is connected to a carbon canister (not shown) and outlet pipe 13 is connected to an intake manifold (not shown) of an associated internal combustion engine. That is, inlet and outlet pipes 12 and 13 constitute part of the evaporation purge line.

As is seen from FIG. 1, lower part 14 is integrally formed with a cylindrical valve seat portion 14A that projects upward. Denoted by “O1-O1” is a center axis of which part constitutes an axis of the cylindrical valve seat portion 14A.

As is seen from FIGS. 1 and 2, lower part 14 is integrally formed at its upper portion with an annular supporting portion 14B that surrounds cylindrical valve seat portion 14A. As is seen from FIG. 2, a top surface of annular supporting portion 14B is slightly higher than that of cylindrical valve seat portion 14A.

As will be described in detail hereinafter, a diaphragm type valve member 18 is operatively put on the top surface of cylindrical valve seat portion 14A.

Between cylindrical valve seat portion 14A and annular supporting portion 14B, there is thus defined an annular passage 14C. As is seen from FIG. 1, annular passage 14C is exposed to an interior of the above-mentioned inlet pipe 12. An interior of cylindrical valve seat portion 14A constitutes an inner passage 14D that is exposed to an interior of the above-mentioned outlet pipe 13.

As is described hereinabove, on lower part 14, there is mounted upper part 15. This upper part 15 of plastic has an electromagnetic actuator 21 integrally installed therein. For this installation, a so-called insert molding technique is used.

As is seen from FIG. 2, upper part 15 has a rounded lower part that comprises an annular ring portion 15A that is mated with the above-mentioned annular supporting portion 14B, an annular stepped portion 15B that extends radially inward from an upper part of the annular ring portion 15A and presses an after-mentioned resilient plate 19 against the top surface of annular supporting portion 14B, a cylindrical stopper portion 15C that is coaxial with the center axis “O1-O1” and projects downward and an annular recess 15D that is defined about stopper portion 15C. As shown, annular recess 15D has an upper wall to which an upper end of a coil spring 27 abuts.

As will become apparent hereinafter, when, due to energization of electromagnetic actuator 21, valve member 18 is lifted to assume its open position, cylindrical stopper portion 15C functions to stop an excessive upper movement of valve member 18. Thus, a lift or open degree of valve member 18 is restricted by stopper portion 15C. As shown, spring 27 is compressed between the upper wall of annular recess 15D and an upper surface of valve member 18. That is, due to function of coil spring 27, valve member 18 is biased toward its close position. As is seen from FIG. 2, annular recess 15D has an outer diameter “S” which will be described in detail hereinafter.

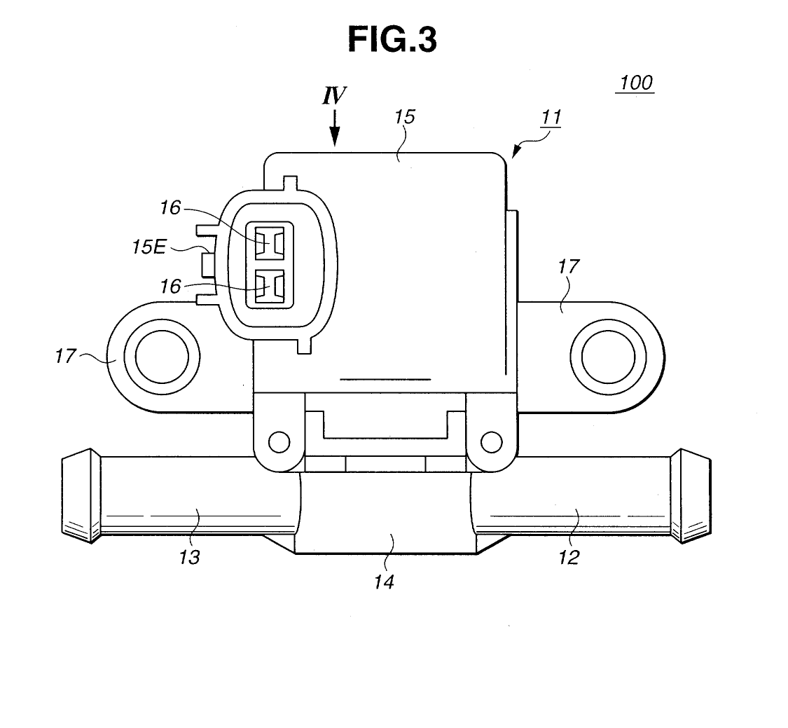

As is seen from FIG. 3, upper part 15 of casing 11 is integrally formed with a connector portion 15E which has two terminal pins 16 and 16 installed therein. These two terminal pins 16 and 16 are used for feeding an electric power to an after-mentioned electromagnetic coil 24 that is also installed in upper part 15 of casing 11.

Referring back to FIG. 1, denoted by numerals 17 and 17 are two brackets that are integrally provided by upper part 15. As is seen from FIG. 3, these brackets 17 and 17 are positioned at a back side of upper part 15 and extend in parallel with inlet and outlet pipes 12 and 13. By means of these brackets 17 and 17, the casing 11, that is, a unit including the lower part 14 and upper part 15 is connected to a desired position of an associated internal combustion engine (not shown).

As is best understood from FIG. 2, valve member 18 located on the top surface of cylindrical valve seat portion 14A comprises a circular plate 18A that is made of a magnetically attractive metal and a circular elastic cover member 18B that covers a lower surface of metal plate 18A. The above-mentioned annular resilient metal plate 19 resiliently holds the metal plate 18A to the top surface of annular supporting portion 14B. A slit O-ring 20 is pressed between the top surface of annular supporting portion 14B and the lower surface of the annular stepped portion 15B, holding a peripheral edge of annular resilient metal plate 19 at its slit part. The metal plate 18A is made of a magnetic steel, magnetic stainless steel or the like. The elastic cover member 18B is made of a soft plastic, natural rubber, synthetic rubber or the like. As shown, elastic cover member 18B is formed at its center portion with a boss that is plugged in a center opening of metal plate 18A to be exposed to the upper surface of metal plate 18A. The boss has a flat upper end that faces a lower end of the above-mentioned cylindrical stopper portion 15C.

As will be described in detail hereinafter, the magnetic metal plate 18A constitutes part of a closed magnetic circuit. If desired, the annular resilient metal plate 19 may be replaced with a resiliently deformable plastic plate.

In response to ON/OFF operation of the electromagnetic actuator 21 which will be described in the following, valve member 18 is moved up and down from and to the top surface of cylindrical valve seat portion 14A thereby to open and close the fluid communication between annular passage 14C connected to inlet pipe 12 and inner passage 14D connected to outlet pipe 13. It is to be noted that the upward and downward movement of valve member 18 is carried out along the center axis “O1-O1”.

Due to provision of elastic cover member 18B, valve member 18 establishes a hermetic sealing against the top surface of valve seat portion 14A when it is seated on the top surface. Due to provision of stopper portion 15C to which the boss of valve member 18 can abut, lift degree or open degree of valve member 18 is restricted. For obtaining a sufficient upward and downward movement of valve member 18, a stepped circular recess “G” is defined in the rounded lower portion of upper part 15, as is best shown in FIG. 2.

As will be understood from the foregoing description, the valve member 18 is of a so-called diaphragm that is operatively placed between lower part 14 and upper part 15 to selectively open and close the fluid communication between inlet and outlet pipes 12 and 13.

For actuating valve member 18, the electromagnetic actuator 21 is employed, which, as is seen from FIGS. 1 and 2, comprises generally a core rod 23, the above-mentioned electromagnetic coil 24 and a yoke member 25. The coil 24 is concentrically held by a plastic coil bobbin 22 that is concentrically disposed about core rod 23. The coil bobbin 22 is formed with a center bore 22A that tightly receives therein core rod 23.

As is seen from FIG. 1, upon assembly, an axis “O2-O2” of core rod 23 extends perpendicular to the center axis “O1-O1” of cylindrical valve seat portion 14A. In other words, the center bore 22A of coil bobbin 22 extends in parallel with a common axis of the two brackets 17 and 17.

As shown, coil bobbin 22 is positioned above valve member 18, and center bore 22A of coil bobbin 22 extends along the axis “O2-O2” that is perpendicular to the center axis “O1-O1”.

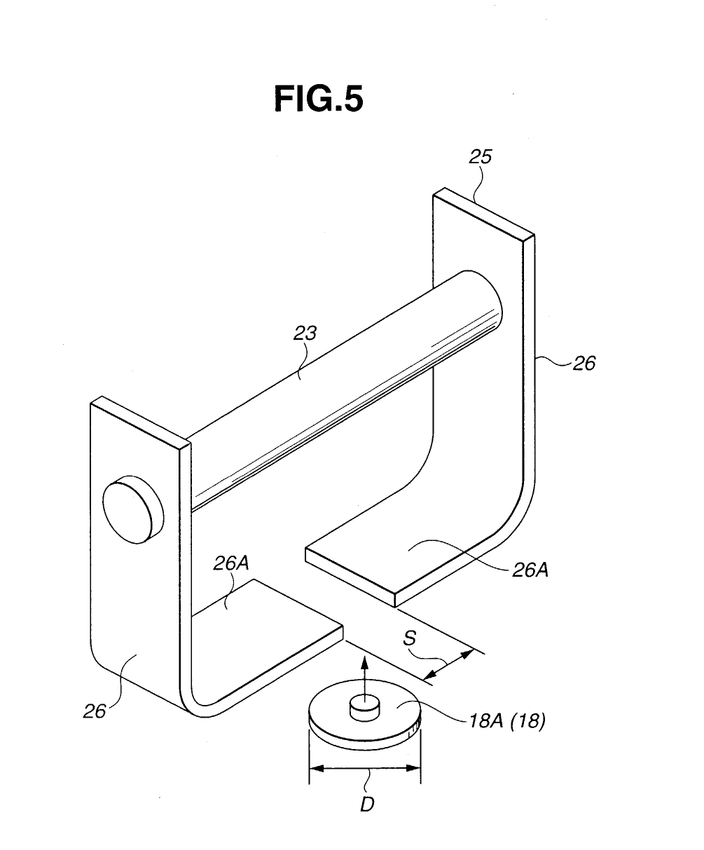

As is best seen from FIG. 5, core rod 23 is cylindrical in shape and made of an iron, magnetic stainless steel or the like. The core rod 23 has both ends tightly held by two L-shaped arm members 26 and 26 of yoke member 25. Caulking, press fitting, welding or the like may be used for securing core rod 23 to arm members 26 and 26. As shown, these two arm members 26 and 26 extend in parallel with core rod 23.

Referring back to FIG. 1, electromagnetic coil 24 held by coil bobbin 22 is arranged to concentrically surround core rod 23. Terminal ends of coil 24 are connected to the above-mentioned terminal pins 16 and 16 (see FIG. 3). Thus, when an electric connector plug (not shown) is connected to the connector portion 15E, electric power can be fed to coil 24 for energizing the same.

As is seen from FIG. 5, the two arm members 26 and 26 of yoke member 25 have inwardly extending lower portions 26A and 26A whose leading ends face each other with a certain clearance left therebetween. The length of the clearance is “S”. These two arm members 26 and 26 are made of an iron, magnetic stainless steel or the like. As will become apparent as the description proceeds, the lower portions 26A and 26A serve as a work part of the electromagnetic actuator 21.

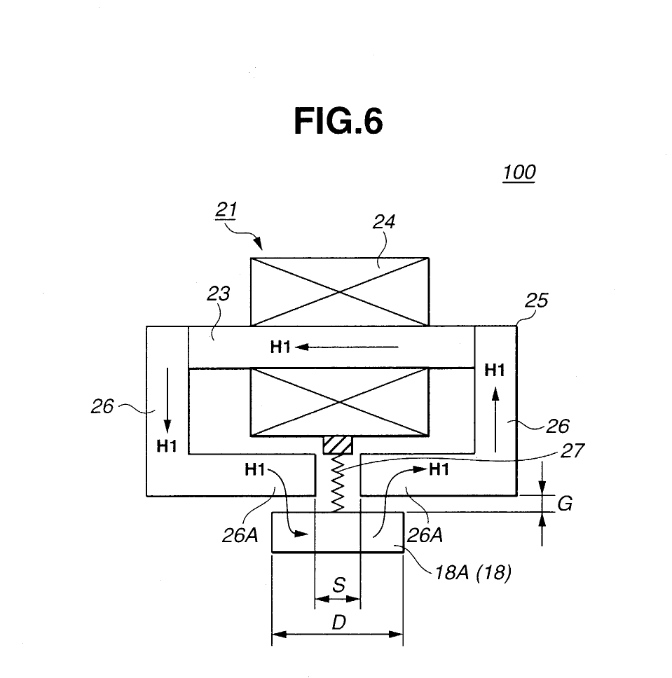

As is seen from FIGS. 5 and 6, the length “S” of the clearance is smaller than an outer diameter “D” of the circular magnetic plate 18A of valve member 18, but larger than an after-mentioned gap “G”. That is, G<S<D is established. As will be understood from FIG. 2, the diameter “S” of annular recess 15D of upper part 15 is equal to the length “S” of the clearance defined between the lower portions 26A and 26A of yoke member 25.

As is seen from FIGS. 2 and 6, the gap “G” is a clearance defined between an upper surface of the circular magnetic plate 18A and a lower surface of each lower portion 26A of yoke member 25 when the valve member 18 assumes its close position.

It is now to be noted that due to provision of the clearance “S”, the two lower portions 26A and 26A are magnetically insulated from each other and function to attract circular magnetic plate 18A of valve member 18 when electromagnetic coil 24 is energized.

Referring to FIG. 6, there is schematically shown the solenoid valve 100 of the first embodiment that has the above-mentioned construction.

When now electromagnetic actuator 21 is energized, there is produced a closed magnetic circuit that is depicted by the arrows “H1”. It is to be noted that circular magnetic plate 18A of valve member 18 constitutes part of the closed magnetic circuit.

Upon energization of actuator 21, valve member 18 is lifted up toward lower portions 26A and 26A of yoke member 25 inducing an open condition of solenoid valve 100. While, upon deenergization of actuator 21, the closed magnetic circuit disappears thereby inducing a close condition of solenoid valve 100 with the aid of coil spring 27.

In the following, operation of solenoid valve 100 of the first embodiment will be described with reference to the drawings, particularly, FIGS. 1, 2 and 6, in a case wherein the valve 100 is used as a purge control valve of an evaporation purge system of an internal combustion engine.

For ease of understanding, description will be commenced with respect to a close condition of solenoid valve 100.

In this close condition, electromagnetic coil 24 of electric actuator 21 is deenergized, and thus, there is produced no magnetic force that attracts or pulls valve member 18 toward the lower portions 26A and 26A of yoke member 25. Thus, under this condition, valve member 18 is enforcedly seated on the top surface of cylindrical valve seat portion 14A due to the biasing force of coil spring 27, and thus the fluid connection between inlet and outlet pipes 12 and 13 is not established. Accordingly, under this close condition, the fuel vapor that has been trapped by the canister is not led into the intake manifold of the engine.

When now electromagnetic coil 24 is energized, there is produced the above-mentioned closed magnetic circuit on the unit including core rod 23 and yoke member 25. Upon this, due to the attracting force produced by lower portions 26A and 26A of yoke member 25, valve member 18 is moved upward against the biasing force of coil spring 27 thereby to open the fluid connection between inlet and outlet pipes 12 and 13. Accordingly, under this open condition, the fuel vapor that has been trapped by the canister is led into the intake manifold and burnt in combustion chambers of the engine together with the air/fuel mixture.

In the following, advantages possessed by solenoid valve 100 of the first embodiment will be described.

As is understood from the above and FIG. 2, in solenoid valve 100, a diaphragm type valve member is used as valve member 18. In response to ON/OFF operation of electromagnetic actuator 21, the diaphragm type valve member 18 carries out the open/close operation very smoothly and responsively. That is, upward and downward movement of valve member 18 can be freely made without being interrupted by friction resistance. This induces an assured, reliable and responsive operation of the evaporation purge system of the internal combustion engine. As has been mentioned hereinbefore, if the valve proper is of a slider type that has to bear a frictional force when moved, responsive open/close operation of the valve is not expected.

Due to the unique arrangement of the parts 23, 24, 25, 27 and 18A of electromagnetic actuator 21 (see FIG. 6), the open/close movement of valve member 18A is smoothly carried out without being interrupted by an undesirable magnetic resistance produced by electromagnetic actuator 21. That is, because of production of the closed magnetic circuit as indicated by the arrows “H1” in FIG. 6, energy loss at the time when the actuator 21 is energized can be minimized.

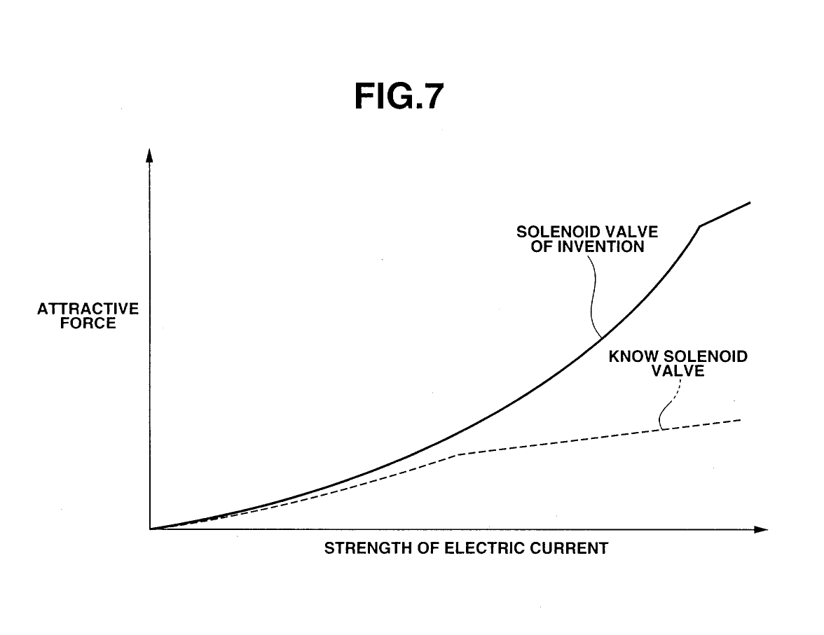

FIG. 7 is a graph that shows, by a solid curve, a relation between the strength of electric current applied to the actuator 21 and the attractive force produced by the same. For comparison, the relation in case of a known solenoid valve is also shown by a broken curve. As is seen from this graph, in the present invention, due to the closed magnetic circuit, sufficiently large attractive force is obtained as compared with the known solenoid valve. Thus, if desired, the capacity and the number of turns of electromagnetic coil 24 may be reduced, which brings about a compact and inexpensive construction of solenoid valve 100.

As is seen from FIG. 1, core rod 23 and electromagnetic coil 24 are so arranged that their common axis “O2-O2” extends perpendicular to the center axis “O1-O1” in which valve member 18 is moved for its open/close operation. Accordingly, core rod 23 and yoke member 25 can have each a simple construction. Furthermore, due to usage of annular resilient metal plate 19, valve member 18 can be resiliently held by casing 11.

Because valve member 18 includes only circular metal plate 18A, circular elastic cover member 18B and annular resilient metal plate 19, entire construction of valve member 18 can be made light in weight. Thus, a responsive action of valve member 18 is achieved in response to the ON/OFF operation of electromagnetic actuator 21.

Almost all parts of electromagnetic actuator 21 are installed in plastic upper part 15 of casing 11 by means of insert-molding technique. This brings about an easiness with which solenoid valve 100 can be assembled.

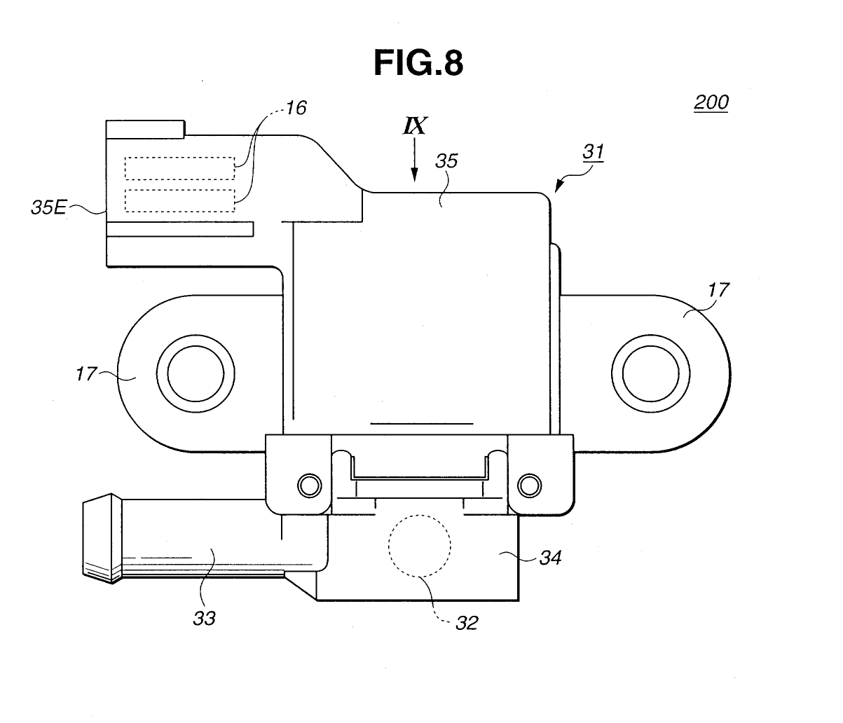

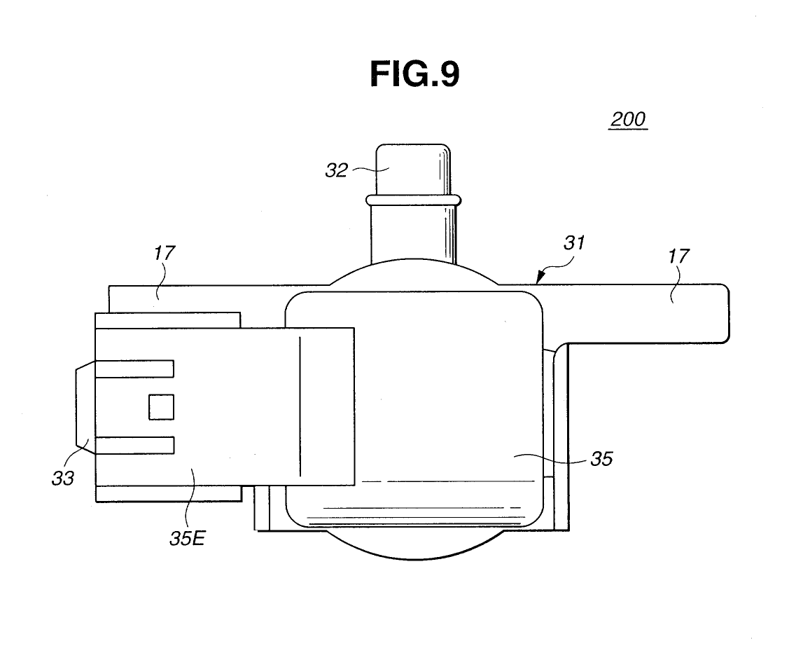

Referring to FIGS. 8 and 9, there is shown a solenoid valve 200 which is a second embodiment of the present invention.

As is seen from the drawings, similar to the above-mentioned embodiment 100, the solenoid valve 200 comprises a plastic casing 31 that corresponds to casing 11 of the first embodiment 100 and comprises a lower part 34 and an upper part 35. Inlet and outlet pipes 32 and 33 of lower part 34 are arranged to extend perpendicular to each other. The upper part 35 has a connector portion 35E which has two terminal pins 16 and 16 installed therein. Although not shown in the drawings, these terminal pins 16 and 16 are connected to an electromagnetic coil 24 installed in upper part 35 of casing 31. As is seen from FIG. 8, the connector portion 35E has at its left end a plug insert opening into which an electric connector plug (not shown) is inserted for feeding the electromagnetic coil with an electric power.

Because of similar construction to the above-mentioned solenoid valve 100 of the first embodiment, solenoid valve 200 of the second embodiment has substantially the same advantages as those of the first embodiment.

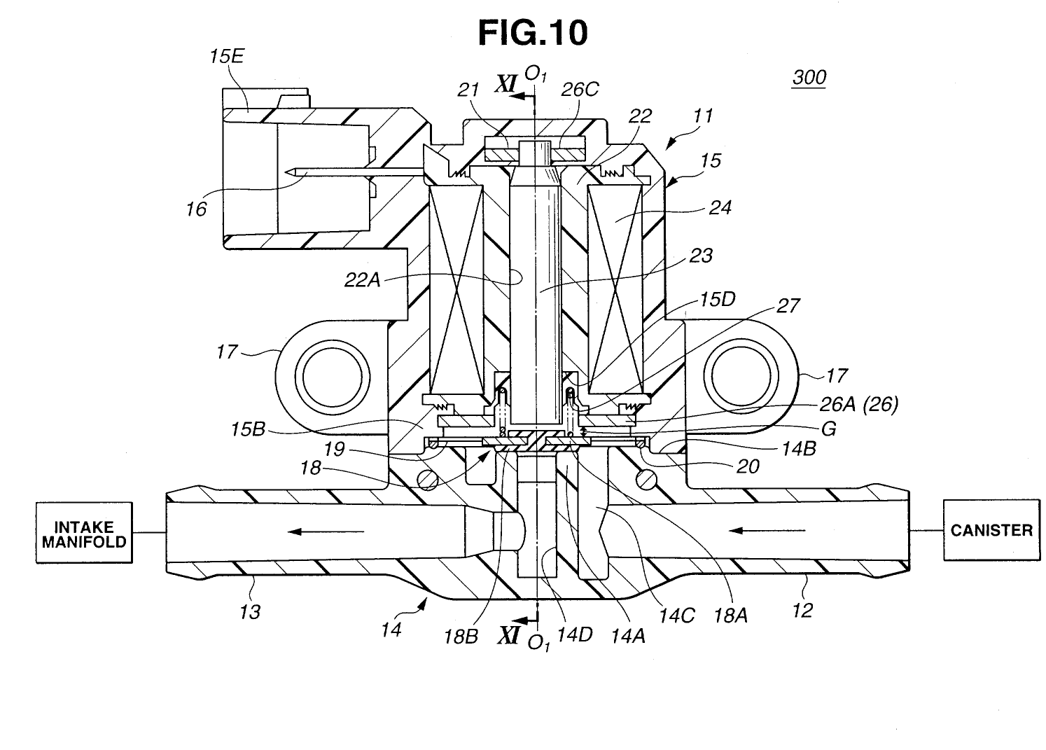

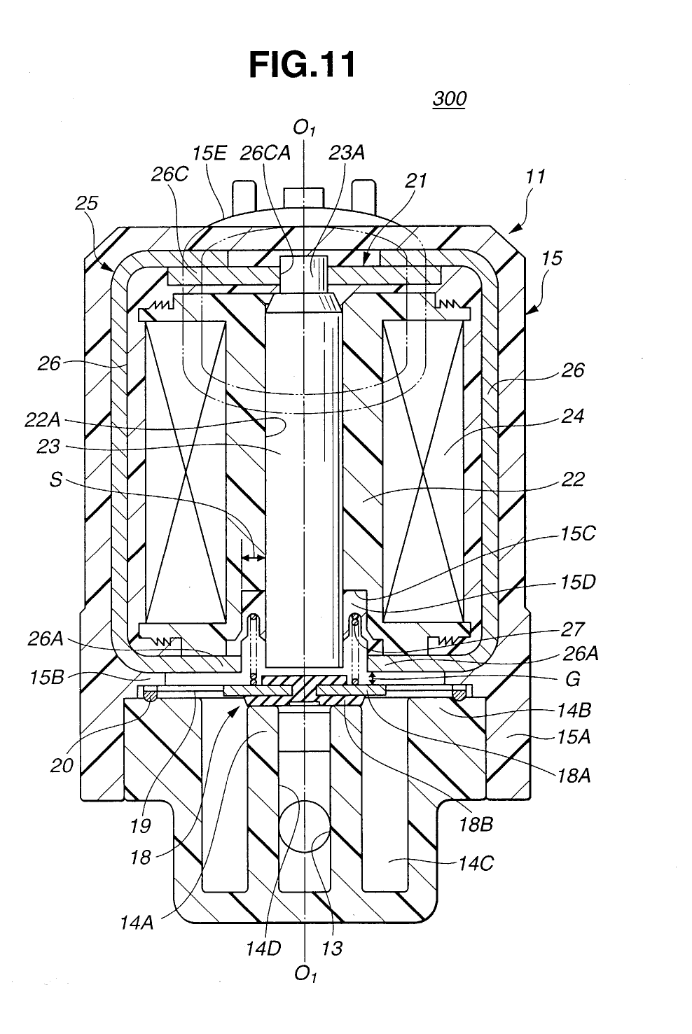

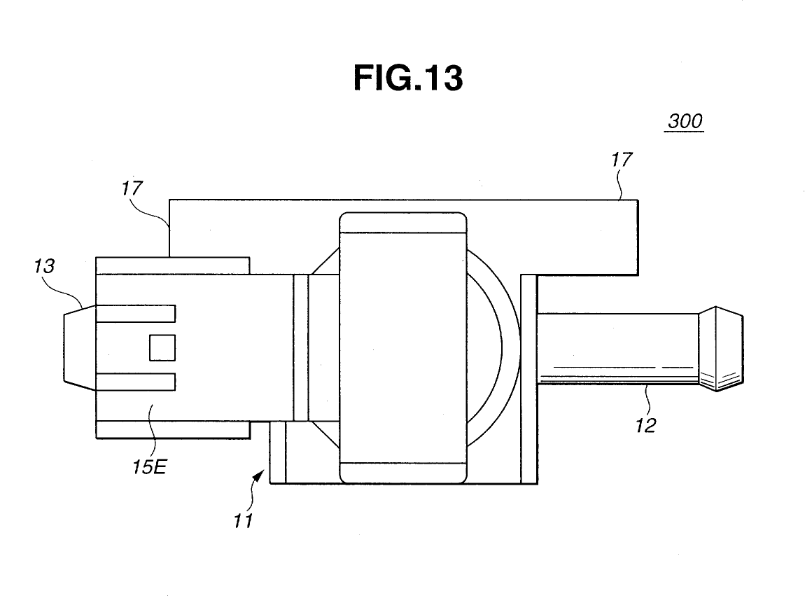

Referring to FIGS. 10 to 15, particularly FIGS. 10 and 11, there is shown a solenoid valve 300 of a third embodiment of the present invention, which is used as a purge control valve.

In FIGS. 10 and 11, denoted by numeral 11 is a split-type casing made of a molded plastic. Similar to the above-mentioned first embodiment 100, casing 11 generally comprises two parts, which are a lower part 14 that has inlet and outlet pipes 12 and 13 which are aligned, and an upper part 15 that is detachably mounted on lower part 14. Inlet pipe 12 is connected to a carbon canister (not shown) and outlet pipe 13 is connected to an intake manifold (not shown) of an associated internal combustion engine. That is, inlet and outlet pipes 12 and 13 constitute part of an evaporation purge line.

As is seen from FIG. 10, lower part 14 is integrally formed with a cylindrical valve seat portion 14A that projects upward. Denoted by “O1-O1” is a center axis of cylindrical valve seat portion 14A.

As is seen from FIGS. 10 and 11, lower part 14 is integrally formed at its upper portion with an annular supporting portion 14B that surrounds cylindrical valve seat portion 14A. As is seen from the drawings, a top surface of annular supporting portion 14B is slightly higher than that of cylindrical valve seat portion 14A.

A diaphragm type valve member 18 is operatively put on the top surface of cylindrical valve seat portion 14A in such a manner as will be described in detail hereinafter.

Between cylindrical valve seat portion 14A and annular supporting portion 14B, there is thus defined an annular passage 14C. As is seen from FIG. 10, annular passage 14C is exposed to an interior of inlet pipe 12. An interior of cylindrical valve seat portion 14A constitutes an inner passage 14D that is exposed to an interior of outlet pipe 13.

On the lower part 14, there is mounted the upper part 15. This upper part 15 of plastic has an electromagnetic actuator 21 integrally installed therein.

As is seen from FIG. 11, upper part 15 has a rounded lower part that comprises an annular ring portion 15A that is mated with the above-mentioned annular supporting portion 14B, an annular stepped portion 15B that extends radially inward from an upper part of the annular ring portion 15A and presses an after-mentioned resilient plate 19 against the top surface of annular supporting portion 14B, a circular recess 15C that is coaxial with the center axis “O1-O1” and perpendicularly exposed to the top surface of cylindrical valve seat portion 14A and an annular plastic plug member 15D that is snugly received in circular recess 15C. As shown, annular plastic plug member 15D has at its lower end an annular groove (no numeral) into which an upper end of a coil spring 27 is received. As shown, coil spring 27 is compressed between annular plastic plug member 15D and circular valve member 18. That is, due to function of spring 27, valve member 18 is biased toward its close position.

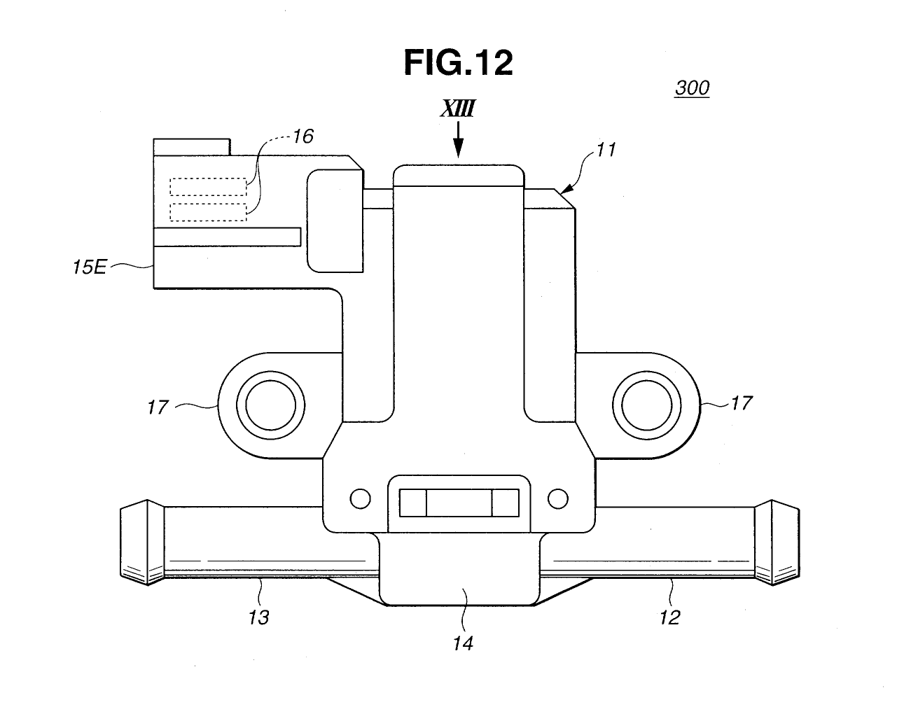

As is seen from FIG. 12, upper part 15 of casing 11 is integrally formed with a connector portion 15E which has two terminal pins 16 and 16 installed therein. These two terminal pins 16 and 16 are used for feeding an electric power to an after-mentioned electromagnetic coil 24 that is also installed in upper part 15 of casing 11.

Referring back to FIG. 10, denoted by numerals 17 and 17 are two brackets that are integrally provided by upper part 15. As is seen from FIG. 12, these brackets 17 and 17 are positioned at a back side of upper part 15 and extend in parallel with inlet and outlet pipes 12 and 13. By means of these brackets 17 and 17, the casing 11, that is, a unit including lower part 14 and upper part 15 can be fixed to a desired position of an associated internal combustion engine (not shown).

As is best seen from FIG. 11, valve member 18 seated on the top surface of cylindrical valve seat portion 14A comprises a circular plate 18A that is made of a magnetically attractive metal and a circular elastic cover member 18B that covers upper and lower surfaces of the circular plate 18A. The above-mentioned annular resilient metal plate 19 resiliently holds metal plate 18A to the top surface of annular supporting portion 14B. A slit O-ring 20 is sandwiched between the top surface of annular supporting portion 14B and the lower surface of the annular stepped portion 15B, holding a peripheral edge of annular resilient metal plate 19 at its slit part. The metal plate 18A is made of a magnetic steel, magnetic stainless steel or the like. The elastic cover member 18B is made of a soft plastic, natural rubber, synthetic rubber or the like. As shown, elastic cover member 18B is formed with a center stud portion through which lower and upper flat portions (no numerals) are connected. For receiving the center stud portion, the metal plate 18A is formed with an opening (no numeral). The upper flat portion of elastic cover member 18B faces the top surface of the above-mentioned circular recess 15C.

As will be described in detail hereinafter, magnetic metal plate 18A constitutes part of a closed magnetic circuit. A resiliently deformable plastic plate may be used as a substitute for the resilient metal plate 19.

In response to ON/OFF operation of the electromagnetic actuator 21, the above-mentioned circular valve member 18 is moved up and down from and to the top surface of cylindrical valve seat portion 14A. With this moving of the valve member 18, the fluid communication between annular passage 14C connected to inlet pipe 12 and inner passage 14D connected to outlet pipe 13 is opened and closed selectively. It is to be noted that the upward and downward movement of the valve member 18 is made along the center axis “O1-O1”. For obtaining a sufficient upward and downward movement of the valve member 18, a stepped circulate recess “G” is defined in the rounded lower portion of the upper part 15 of casing 11, as is seen from FIG. 11.

Like in the above-mentioned first and second embodiments 100 and 200, the valve member 18 is a so-called diaphragm that is operatively placed between lower part 14 and upper part 15 to selectively open and close the fluid communication between inlet and outlet pipes 12 and 13.

For actuating valve member 18, the electromagnetic actuator 21 is employed, which, as is seen from FIGS. 10 and 11, comprises generally a core rod 23, the above-mentioned electromagnetic coil 24 and a yoke member 25. The coil 24 is stably held by a plastic coil bobbin 22 that is arranged to surround core rod 23. The coil bobbin 22 is formed with a center bore 22A that tightly receives therein core rod 23.

As is seen from FIG. 10, upon assembly, an axis of core rod 23 coincides with the center axis “O1-O1” of cylindrical valve seat portion 14A. In other words, the center bore 22A of coil bobbin 22 extends perpendicular to a common axis of the two brackets 17 and 17.

As shown, coil bobbin 22 is positioned above the circular valve member 18, and center bore 22A of coil bobbin 22 extends along the center axis “O1-O1”.

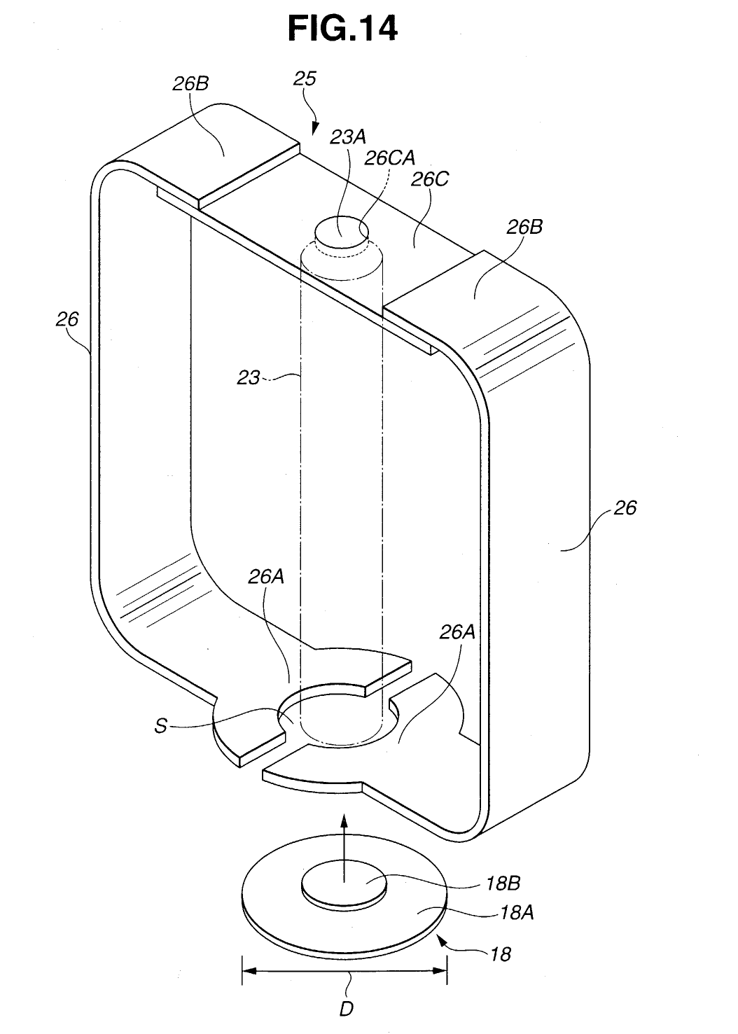

As is best seen from FIG. 14, the core rod 23 is cylindrical in shape and made of iron, magnetic stainless steel or the like.

As is understood from FIGS. 11 and 14, core rod 23 stands vertically having its lower end exposed to circular recess 15C. The lower end of core rod 23 faces the valve member 18 keeping a certain clearance “G” therebetween. The core rod 23 has a smaller upper end 23A tightly fitted in an opening 26Ca of an after-mentioned bridge member 26C of yoke member 25. Caulking, press fitting, welding or the like is used for securing the smaller upper end 23A to the bridge member 26C.

Referring back to FIG. 10, electromagnetic coil 24 held by coil bobbin 22 is arranged to concentrically surround core rod 23. Terminal ends of coil 24 are connected to terminal pins 16 and 16 of the above-mentioned connector portion 15E. Thus, when an electric connector plug (not shown) is connected to connector portion 15E, electric power can be fed to coil 24 to energize the same.

As is understood from FIG. 14, yoke member 25 is shaped generally rectangular and arranged to surround electromagnetic coil 24 held on coil bobbin disposed on core rod 23. Yoke member 25 comprises two side arm members 26 and 26 each having inwardly extending lower and upper portions 26A and 26B. As shown, leading ends of lower portions 26A and 26A of the two side arm members 26 and 26 are enlarged and semi-circularly shaped to concentrically surround the lower end of core rod 23. For this surrounding, each leading end of the lower portions 26A and 26A has a semicircular recess that surrounds the cylindrical outer surface of core rod 23. Designated by reference “S” is a given annular clearance that is defined between the leading ends and the core rod 23 when the actuator 21 is properly assembled.

As shown, inwardly extending upper portions 26B and 26B of the two side arm members 26 and 26 are connected through the above-mentioned bridge member 26C. The bridge member 26C is connected to the upper portions 26B and 26B by means of welding or the like. The two side arm members 26 and 26 and bridge member 26C are made of iron, magnetic stainless steel or the like.

Referring back to FIG. 11, under close condition of the valve member 18, there is defined a given clearance “G” between each lower portion 26A of the side arm members 26 and 26 and the valve member 18. The given clearance “G” is smaller than the above-mentioned annular clearance “S”. As shown, lower surfaces of lower portions 26A and 26A of arm members 26 and 26 are substantially flush with a flat surface defined on the lower end of core rod 23.

Due to presence of annular clearance “S”, each lower portion 26A and core rod 23 are magnetically insulated from each other. Upon energization of magnetic coil 24, the lower portions 26A and 26A of yoke member 25 and the lower portion of core rod 23 function to attract the valve member 18 thereby opening the fluid communication between inlet and outlet pipes 12 and 13. Because the upper end 23A of core rod 23 are connected to bridge member 26C, these two members 23 and 26C and two side arm members 26 and 26 are magnetically connected.

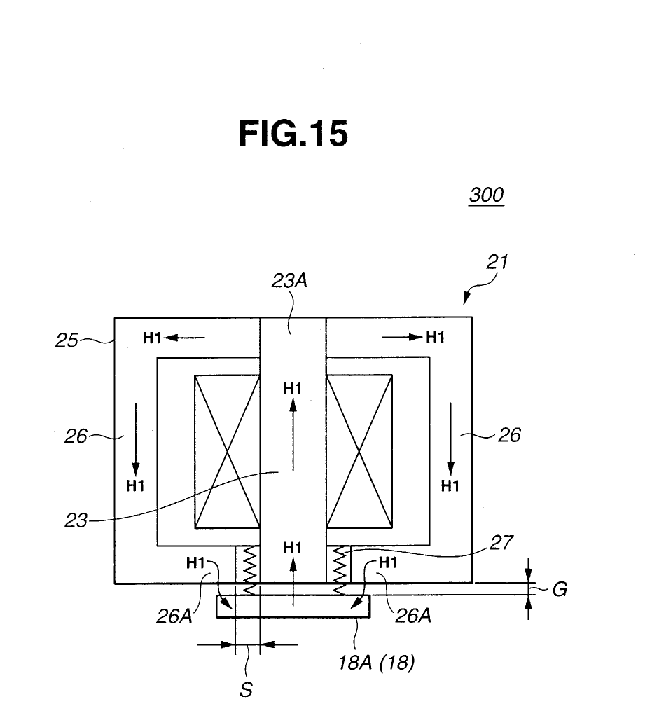

Referring to FIG. 15, there is schematically shown the solenoid valve 300 of the third embodiment that has the above-mentioned construction.

When now electromagnetic actuator 21 is energized, there is produced a closed magnetic circuit that is depicted by the arrows “H1”. It is to be noted that circular magnetic plate 18A of valve member 18 constitutes part of the closed magnetic circuit.

Upon energization of actuator 21, valve member 18 is lifted up toward the lower end of core rod 23 inducing an open condition of solenoid valve 300. While, upon deenergization of actuator 21, the closed magnetic circuit disappears thereby inducing a close condition of solenoid valve 300 with the aid of coil spring 27.

In the following, operation of solenoid valve 300 of the third embodiment will be described with reference to the drawings, particularly FIGS. 10, 11 and 15, in a case wherein the valve 300 is used as a purge control valve of an evaporation purge system of an internal combustion engine.

For ease of understanding, description will be commenced with respect to a close condition of solenoid valve 300, viz., the purge control valve.

In the closed condition, electromagnetic coil 24 of actuator 21 is deenergized, and thus, there is produced no magnetic force that attracts or pulls valve member 18 toward the lower end of core rod 23. Thus, under this condition, valve member 18 is enforcedly seated on the top surface of cylindrical valve seat portion 14A due to the biasing force of coil spring 27, and thus the fluid connection between inlet and outlet pipes 12 and 13 is not established. Accordingly, under this condition, the fuel vapor that has been trapped by the canister is not led into the intake manifold of the engine.

When now electromagnetic coil 24 is energized, there is produced the above-mentioned closed magnetic circuit on a unit including core rod 23 and yoke member 25. Upon this, due to an attracting force produced by the lower end of core rod 23 and lower portions 26A and 26A of the two side arm members 26 and 26, the valve member 18 is moved upward against the biasing force of coil spring 27 thereby to pen the fluid connection between inlet and outlet pipes 12 and 13. Thus, under this open condition, the fuel vapor that has been trapped by the canister is led into the intake manifold and burnt in combustion chambers of the engine together with the air/fuel mixture.

In the following, advantages possessed by the solenoid valve 300 will be described.

Also in this third embodiment, a diaphragm type valve member is used as the valve member 18. That is, upward and downward movement of the valve member 18, that induces open/close operation of the valve, can be freely made without being interrupted by friction resistance. Thus, assured and resonsive operation of the evaporation purge system of the internal combustion engine is established.

Due to the unique arrangement of the parts 23, 24, 25, 27 and 18A of electromagnetic actuator 21 (see FIG. 15), the open/close movement of valve member 18 is smoothly carried out without being interrupted by an undesirable magnetic resistance produced by actuator 21. Because of production of the closed magnetic circuit as indicated by the arrows “H1” in FIG. 15, energy loss at the time when the actuator 21 is energized can be minimized.

As is seen from FIG. 10, core rod 23 and electromagnetic coil 24 are so arranged that their common axis is the same as the center axis “O1-O1” in which valve member 18 is moved for its open/close operation. Thus, core rod 23 and yoke member 25 can have each a simple construction. Due to usage of annular resilient metal plate 19, the valve member 18 can be resiliently held by casing 11.

Because valve member 18 includes only circular metal plate 18A, elastic cover member 18B and annular resilient metal plate 19, entire construction of valve member 18 can be made light in weight. Thus, a responsive action of the valve member 18 is achieved in response to the ON/OFF operation of electromagnetic actuator 21.

Almost all parts of electric actuator 21 are installed in the plastic upper part 15 of casing 11 by means of insert-molding technique. This brings about an easiness with which solenoid valve 300 can be assembled.

The entire contents of Japanese Patent Applications 2002-118212 (filed Apr. 19, 2002) and 2002-118213 (filed Apr. 19, 2002) are incorporated herein by reference.

Although the invention has been described above with reference to the embodiments of the invention, the invention is not limited to such embodiments as described above. Various modifications and variations of such embodiments may be carried out by those skilled in the art, in light of the above description.

What is claimed is:

1. A solenoid valve comprising:
a casing defining therein inlet and outlet passages and a valve seat, the valve seat establishing a fluid communication between the inlet and outlet passages when opened and blocking the fluid communication when closed;
a diaphragm type valve member installed in the casing, the valve member being movable between an open position wherein the valve member is separated from the valve seat thereby to open the same and a close position wherein the valve member is seated on the valve seat thereby to close the same, the valve member having thereon a magnetic material;
a biasing member that biases the valve member in a direction to cause the valve member to assume the close position; and
an electromagnetic actuator installed in the casing, the actuator having a work part that faces the valve member, the work part producing a magnetic force to attract the valve member causing the same to assume the open position against a biasing force of the biasing member when the actuator is energized and producing no magnetic force to leave the valve member causing the same to assume the close position due to the biasing force of the biasing member when the actuator is deenergized.

2. A solenoid valve as claimed in claim 1, in which the diaphragm type valve member comprises:
a magnetic metal plate arranged over the valve seat, the magnetic metal plate having an upper surface that faces the work part of the electromagnetic actuator and a lower surface that faces the valve seat;
an elastic cover member covering at least the lower surface of the magnetic metal plate; and
a resilient metal plate resiliently connecting the magnetic metal plate to a fixed portion of the casing.

3. A solenoid valve as claimed in claim 2, in which the magnetic metal plate and the elastic cover member are circular in shape and the resilient metal plate is annular in shape, and in which a unit including the magnetic metal plate and the elastic cover member is held in a circular opening of the annular resilient metal plate.

4. A solenoid valve as claimed in claim 2, in which the elastic cover member is integrally formed with an upper covering portion that covers the upper surface of the magnetic metal plate, the upper covering portion being brought into abutment with a stopper portion of the solenoid valve when, due to energization of the electromagnetic actuator, the valve member is moved toward the work part of the actuator.

5. A solenoid valve as claimed in claim 4, in which the stopper portion of the solenoid valve is defined by either one of the casing and the work part.

6. A solenoid valve as claimed in claim 4, in which the upper covering portion is shaped into a projection that is directed toward the stopper portion.

7. A solenoid valve as claimed in claim 3, further comprising an O-ring that is sandwiched between the annular resilient metal plate and a given portion of the casing.

8. A solenoid valve as claimed in claim 1, in which the biasing member is a coil spring that is compressed between valve member and a given portion of the casing.

9. A solenoid valve as claimed in claim 3, in which the casing is constructed of a plastic and comprises:
a lower part that has the inlet and outlet passages and the valve seat defined therein; and
an upper part that has the electromagnetic actuator installed therein,
the upper part being detachably mounted on the lower part in a manner to define therebetween a given space in which the valve member and the biasing member are operatively installed.

10. A solenoid valve as claimed in claim 9, in which the work part of the electromagnetic actuator is exposed to the given space and faces an upper surface of the magnetic metal plate of the valve member.

11. A solenoid valve as claimed in claim 10, in which the electromagnetic actuator comprises:
a core rod;
an electromagnetic coil coaxially mounted on the core rod through a coil bobbin; and
a yoke member including two arm members by which the core rod is held.

12. A solenoid valve as claimed in claim 11, in which the two arm members are L-shaped arm members between which the core rod extends, the arm members having inwardly extending lower portions whose leading ends face each with a given clearance left therebetween.

13. A solenoid valve as claimed in claim 12, in which the lower portions of the yoke member face the upper surface of the magnetic metal plate of the valve member thereby to serve as the work part of the electromagnetic actuator.

14. A solenoid valve as claimed in claim 13, in which the length of the given clearance defined between the leading ends of the lower portions of the arm member is greater than the thickness of the given space defined between the lower and upper parts of the casing but smaller than the diameter of the magnetic metal plate of the valve member.

15. A solenoid valve as claimed in claim 11, in which the yoke member is a generally rectangular yoke member including two side arm members whose upper ends are connected through a bridge member, the arm members having inwardly extending lower portions whose leading ends face each other with a given clearance left therebetween, the core rod having an upper end secured to the bridge member and a lower end positioned between the leading ends of the inwardly extending lower portions of the arm members with an annular clearance left therebetween.

16. A solenoid valve as claimed in claim 15, in which the inwardly extending lower portions of the arm members and the lower end of the core rod face the upper surface of the magnetic metal plate of the valve member thereby to serve as the work part of the electromagnetic actuator.

17. A solenoid valve as claimed in claim 16, in which the width of the annular clearance defined between the lower end of the core rod and the leading ends of the lower portions of the arm member is greater than the thickness of the given space defined between the lower and upper parts of the casing but smaller than the diameter of the magnetic metal plate of the valve member.

18. A solenoid valve as claimed in claim 1, in which the inlet and outlet passages extend perpendicular to each other.

19. A solenoid valve comprising:
a casing defining therein inlet and outlet passages and a valve seat, the valve seat establishing a fluid communication between the inlet and outlet passages when opened and blocking the fluid communication when closed;
a diaphragm type valve member installed in the case, the valve member being movable between an open position wherein the valve member is separated from the valve seat thereby to open the same and a close position wherein the valve member is seated on the valve seat thereby to close same, the valve member having hereon a magnetic material;
a biasing coil that biases the valve member in a direction to cause the valve member to assume the close position; and
an electromagnetic actuator installed in the casing, the actuator comprising a core rod, an electromagnetic coil coaxially mounted on the core rod through a coil bobbin and a yoke member including two arm members by which the core rod is held,
wherein the arm members have inwardly extending lower portions whose leading ends face each other with a given clearance left therebetween, and wherein the lower portions face an upper surface of the valve member thereby to serve as a work part of the electromagnetic actuator, the work part producing a magnetic force applied to the magnetic material of the valve member when the actuator is energized.

20. A solenoid valve comprising:
a casing defining therein inlet and outlet passages and a valve seat, the valve seat establishing a fluid communication between the inlet and outlet passages when opened and blocking the fluid communication when closed;
a diaphragm type valve member installed in the case, the valve member being movable between an open position wherein the valve member is separated from the valve seat thereby to open the same and a close position wherein the valve member is seated on the valve seat thereby to close same, the valve member having hereon a magnetic material;
a biasing coil that biases the valve member in a direction to cause the valve member to assume the close position; and
an electromagnetic actuator installed in the casing, the actuator comprising a core rod, an electromagnetic coil coaxially mounted on the core rod through a coil bobbin and a yoke member including two arm members by which the core rod is held,
wherein the arm members have upper portions connected through a bridge member and inwardly extending lower portions whose leading ends face each other with a given clearance left therebetween, wherein the core rod has an upper end secured to the bridge member and a lower end positioned between the leading ends of the inwardly extending lower portions of the arm members with a given clearance left therebetween, and wherein the inwardly extending lower portions of the arm members and the lower end of the core rod face the upper surface of the valve member thereby to serve as a work part of the electromagnetic actuator, the work part producing a magnetic force applied to the magnetic material of the valve member when the actuator is energized.
